(19) United States
(12) Patent Application Publication
(10) Pub. No.: US 2016/0239713 A1
(43) Pub. Date: Aug. 18, 2016

(54) IN-VEHICLE MONITORING

(71) Applicants: William Allen STONE, Autin, TX (US); Nicholas STOENESCU, Austin, TX (US)

(72) Inventors: William Allen STONE, Autin, TX (US); Nicholas STOENESCU, Austin, TX (US)

(21) Appl. No.: 15/045,229

(22) Filed: Feb. 16, 2016

Related U.S. Application Data
(60) Provisional application No. 62/116,748, filed on Feb. 16, 2015.

(51) Int. Cl. G06K 9/00; B60R 1/00

(52) U.S. Cl. CPC G06K 9/00832; B60R 1/00

(57) ABSTRACT

In-vehicle monitoring systems and associated methods. The systems include a first lens pointed in a first direction, a second lens pointed in a second direction, camera element(s) that receive images from the lenses, interface(s) to storage for the images, and at least one in-vehicle mount for the system. The first lens and the second lens may point in opposite directions. The interface(s) may be at least one micro SD port, SIM card port, USB port, wireless communication element, interface to an included memory, or some combination thereof. The systems may also include a motion detection element, a location detection element, a microphone, a speaker, or some combination thereof. At least some images may be sent to the interface(s) in response to detection of a triggering event, for example a verbal command, a vehicle accident, a vehicle break-in, a police encounter, or a medical emergency.

### CROSS-REFERENCE TO RELATED APPLICATION

This application claims the benefit of U.S. Provisional Application No. 62/116,748 titled “IN-VEHICLE MONITORING SYSTEM” and filed 16 Feb. 2015 in the name of the same inventors as this non-provisional application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present disclosure generally relates to an in-vehicle monitoring system including at least at least one in-vehicle mount, a front lens, and a rear lens.

### SUMMARY

Aspects of the subject technology include in-vehicle monitoring systems and associated methods. The systems include a first lens pointed in a first direction, a second lens pointed in a second direction, camera element(s) that receive images from the lenses, interface(s) to storage for the images, and at least one in-vehicle mount for the system. The first lens and the second lens may point in opposite directions. The interface(s) may be at least one micro SD port, SIM card port, USB port, wireless communication element, interface to an included memory, or some combination thereof. The systems may also include a motion detection element, a location detection element, a microphone, a speaker, or some combination thereof. At least some images may be sent to the interface(s) in response to detection of a triggering event, for example a verbal command, a vehicle accident, a vehicle break-in, a police encounter, or a medical emergency.

This brief summary has been provided so that the nature of the invention may be understood quickly. Additional steps and/or different steps than those set forth in this summary may be used. A more complete understanding of the invention may be obtained by reference to the following description in connection with the attached drawings.

### BRIEF DESCRIPTION OF THE DRAWINGS

FIG. 1 illustrates a perspective view of an in-vehicle monitoring system according to aspects of the subject technology.

FIG. 2 illustrates a front view of an in-vehicle monitoring system according to aspects of the subject technology.

FIG. 3 illustrates a side view of an in-vehicle monitoring system according to aspects of the subject technology.

FIG. 4 illustrates another side view of an in-vehicle monitoring system according to aspects of the subject technology.

FIG. 5 illustrates a bottom view of an in-vehicle monitoring system according to aspects of the subject technology.

FIG. 6 illustrates possible additional elements of an in-vehicle monitoring system according to aspects of the subject technology.

FIG. 7 illustrates possible steps that may be performed by an in-vehicle monitoring system according to aspects of the subject technology.

### DETAILED DESCRIPTION

U.S. Provisional Application No. 62/116,748 titled “IN-VEHICLE MONITORING SYSTEM” and filed 16 Feb. 2015 in the name of the same inventors as this non-provisional application is hereby incorporated by reference as if fully set forth herein.

Briefly, aspects of the subject technology include in-vehicle monitoring systems and associated methods. The systems include a first lens pointed in a first direction, a second lens pointed in a second direction, camera element(s) that receive images from the lenses, interface(s) to storage for the images, and at least one in-vehicle mount for the system. The first lens and the second lens may point in opposite directions. The interface(s) may be at least one micro SD port, SIM card port, USB port, wireless communication element, interface to an included memory, or some combination thereof. The systems may also include a motion detection element, a location detection element, a microphone, a speaker, or some combination thereof. At least some images may be sent to the interface(s) in response to detection of a triggering event, for example a verbal command, a vehicle accident, a vehicle break-in, a police encounter, or a medical emergency.

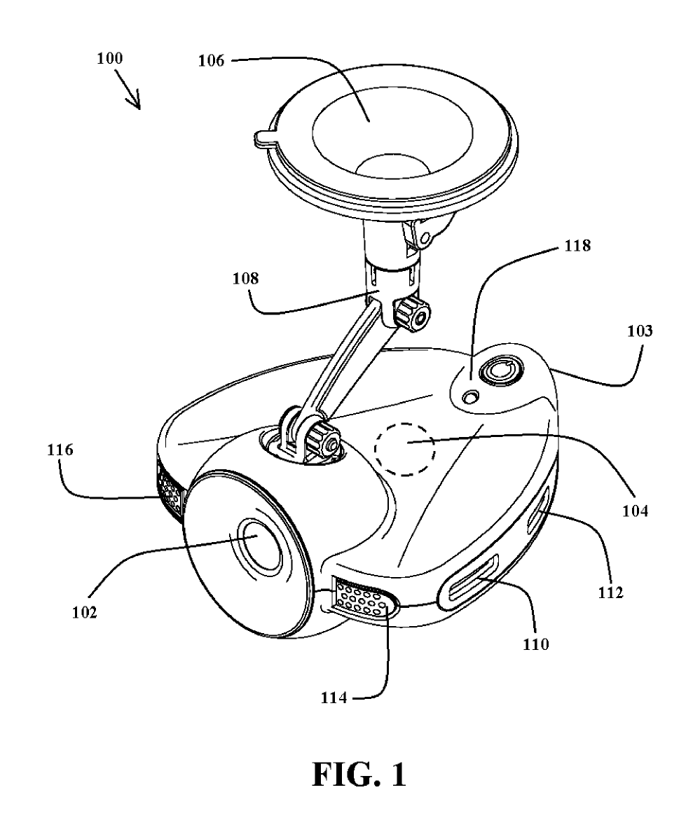

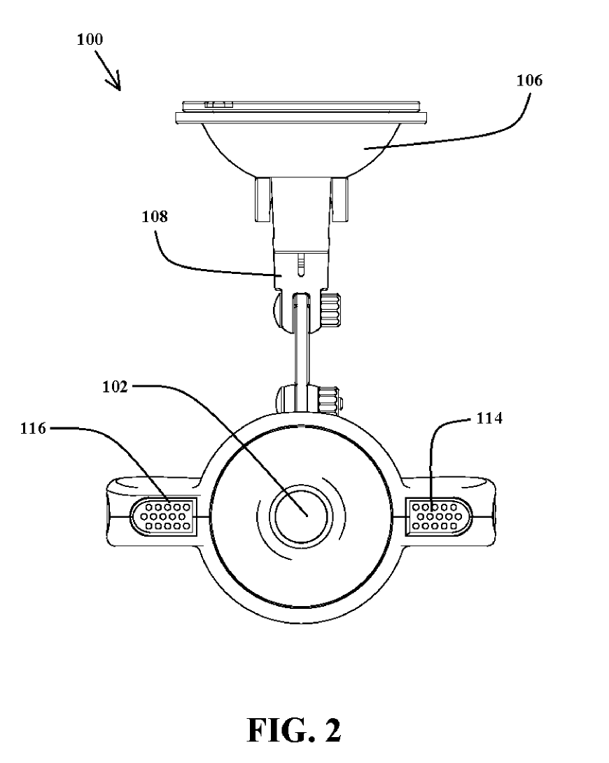

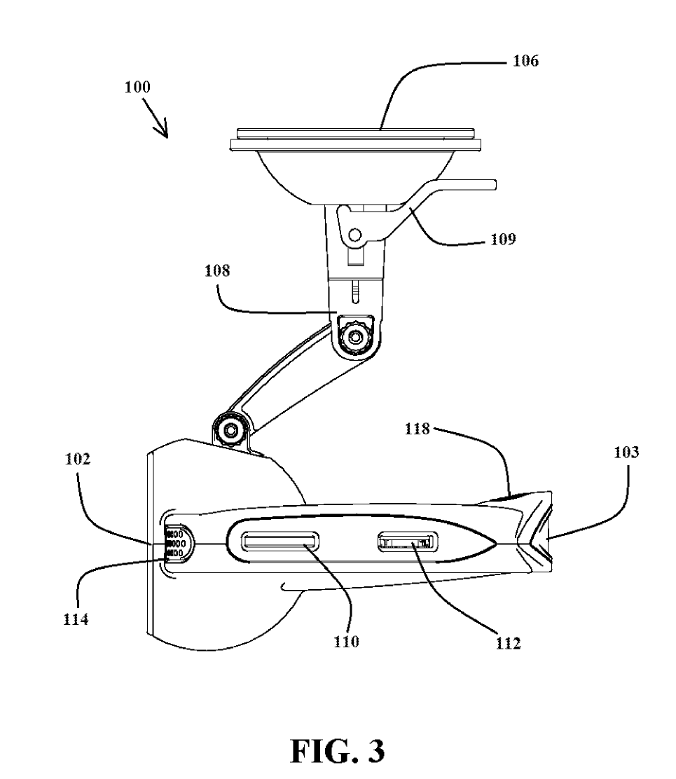

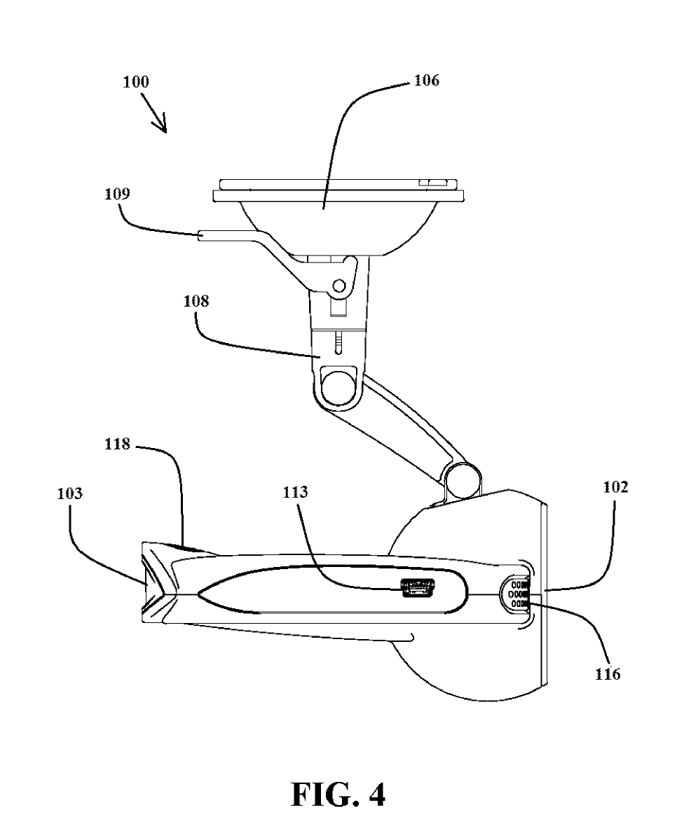

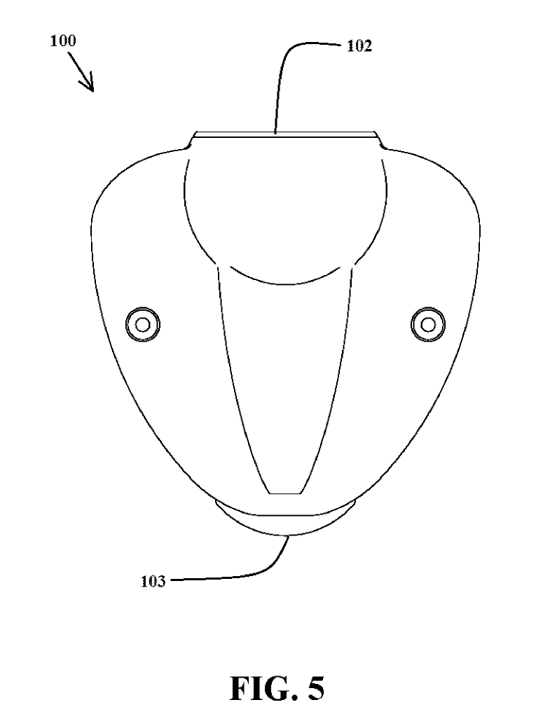

In more detail, FIGS. 1 to 5 illustrate various views of an in-vehicle monitoring system according to aspects of the subject technology. In these figures, in-vehicle monitoring system 100 includes front lens 102 and back lens 103, which preferably are pointed in opposite directions. The lenses may be used to send preferably digital image information to processing and other elements 104 of the system. Elements 104 preferably include one or more digital camera elements that receive images from the lenses.

In-vehicle mount, shown in the form of suction cup 106, mounting structure(s) 108, and possibly lever 109 may be used to mount system 100 inside of a vehicle, for example on a windshield. In this mounted position, lens 102 preferable points toward a front of a vehicle and lens 103 preferably points to a back of a vehicle. Alternatively, the system may be mounted using a different mechanism and/or on a different window such as a side or back window.

Interfaces 110, 112, and 113 represent interfaces to storage for at least some images captured by the at least one camera element in the system. Interface 110 is shown as a SIM card port, interface 112 is shown as a micro SD port, and interface 113 is shown as a USB port. Aspects of the subject technology may include these ports, other ports, or some combination thereof. Alternatively, the ports may be omitted.

In other aspects, an interface to storage for images may be included in elements 104, for example a wireless communication element. Examples of suitable wireless communication elements include but are not limited to WiFi, mobile phone, satellite, and/or other wireless communication elements. One or more such elements may be included in addition to or instead of one or more of the depicted interfaces 110, 112, and/or 113. In still other aspects, the referenced interface may to be memory included in elements 104, again in addition to or instead of the interfaces discussed above.

Other elements depicted as possibly included in in-vehicle monitoring system 100 include audio elements 114 and 116, for example microphones and/or speakers, and power interface 118, for example a power switch and power indicator light (e.g., LED).

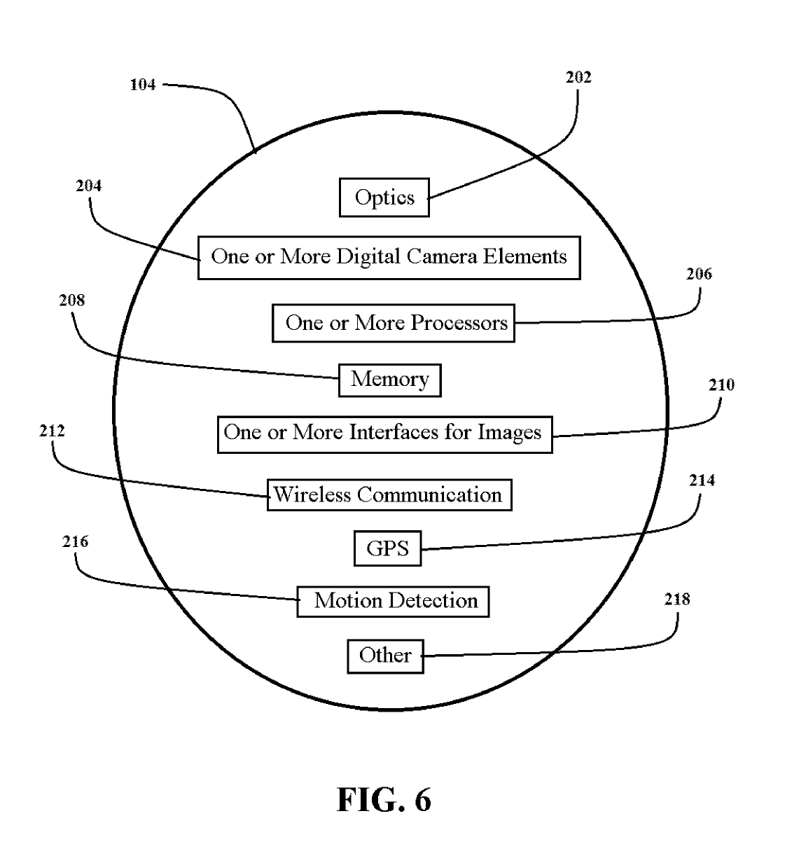

FIG. 6 illustrates possible additional elements of an in-vehicle monitoring system according to aspects of the subject technology. These elements may be included as elements 104 shown in FIGS. 1 to 5, as noted in the figure.

Optics 202 may be used to propagate images from lenses to one or more preferably digital camera elements 204. Examples of suitable digital camera elements include but are not limited to CCD, ICCD, EMCCD, emICCD, X-Ray and InGaAs camera elements.

One or more processors 206 may be used to process images from the digital camera elements. Processing may include but is not limited to compression, motion detection, addition of metadata, and the like. Other functions may also be performed. Instructions for use by the processors as well as unprocessed and processed image data may be stored in memory 208.

FIG. 6 also shows one or more interfaces 210 for images. These interfaces may be part of or may communicate with the interfaces discussed above and/or other interfaces. Additional wireless communication element(s) 212 may also be included, for example for communication with a vehicle's own wireless communication system, a user's mobile computing device (e.g., mobile phone), or the like.

Additional features depicted as possible parts of an in-vehicle monitoring system according to aspects of the subject technology include GPS (Global Positioning System) element(s) 214 and/or motion detection elements 216. These or other elements may be used to by the system to determine a position of a vehicle in which the system is mounted, a speed or acceleration of the vehicle, and the like. Other elements 218 may also be included.

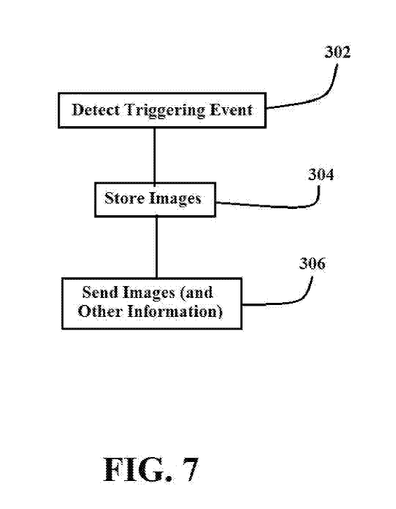

FIG. 7 illustrates possible steps that may be performed by an in-vehicle monitoring system according to aspects of the subject technology. These and other steps may be performed by processor(s) within a mounted in-vehicle monitoring system or by one or more other devices that communicates with the system. Examples of such other devices include but are not limited to a mobile device (e.g., using an “app”), one or more processors in a vehicle, and/or one or more processors running a web site.

In step 302, a triggering event is detected. The triggering event may be turning on an in-vehicle monitoring system, a verbal command, a vehicle accident, a vehicle break-in, a police encounter, and/or a medical emergency. These and other triggering events may be detected via various elements discussed above. For example, a microphone may be used to detect a verbal command, a vehicle break-in (e.g., glass break or repeated failed attempts to open a door), or police encounter. For another example, a GPS and/or motion detection element may be used to detect a vehicle accident. For yet another example, processing of images may be used to detect a triggering event. For a still further example, a vehicle itself or a mobile device (e.g., using an “app”) may detect a triggering event and communicate detection of the event to the in-vehicle monitoring device. Other examples are possible.

Images are stored locally or remotely in step 304, possibly in response to the triggering event detected in step 302. The images and possibly other information such as recorded sound, information about a triggering event, and/or metadata are sent in step 306. The images and/or other information may be sent to a local memory, a connected memory device such as a SIM card, micro SD card, or USB device, remote storage, or some other device.

As discussed above, an in-vehicle monitoring system according to aspects of the subject technology may include or interact with one or more processors. More generally, these processors may be any form of tangible computing elements. Examples of a tangible computing element include but are not limited to a microprocessor, graphical processing unit, application specific integrated circuit, programmable gate array, memristor based device, and the like. A tangible computing element may operate in one or more of a digital, analog, electric, photonic, and/or some other manner. The tangible computing element(s) preferably include or access storage (memory) for instructions and data used to perform steps such as those discussed above.

The invention is in no way limited to the specifics of any particular embodiments and examples disclosed herein. For example, the terms “aspect,” “example,” “preferably,” “alternatively,” and the like denote features that may be preferable but not essential to include in some embodiments of the invention. In addition, details illustrated or disclosed with respect to any one aspect of the invention may be used with other aspects of the invention. Additional elements and/or steps may be added to various aspects of the invention and/or some disclosed elements and/or steps may be subtracted from various aspects of the invention without departing from the scope of the invention. Singular elements/steps imply plural elements/steps and vice versa. Some steps may be performed serially, in parallel, in a pipelined manner, or in different orders than disclosed herein. Many other variations are possible which remain within the content, scope, and spirit of the invention, and these variations would become clear to those skilled in the art after perusal of this application.

What is claimed is:

1. An in-vehicle monitoring system, comprising:
a first lens pointed in a first direction;
a second lens pointed in a second direction different from the first direction;
at least one camera element that receives images from at least the first lens and the second lens;
at least one interface to storage for at least some images captured by the at least one camera element; and
at least one in-vehicle mount for the system.

2. An in-vehicle monitoring system as in claim 1, wherein when the first lens and the second lens point in opposite directions.

3. An in-vehicle monitoring system as in claim 1, wherein the at least one interface comprises at least one micro SD port, SIM card port, USB port, or some combination thereof.

4. An in-vehicle monitoring system as in claim 1, wherein the at least one interface comprises at least one wireless communication element.

5. An in-vehicle monitoring system as in claim 1, further comprising at least one memory, wherein the at least one interface comprises at least one interface to the at least one memory.

6. An in-vehicle monitoring system as in claim 1, further comprising a motion detection element, a location detection element, or some combination thereof.

7. An in-vehicle monitoring system as in claim 1, further comprising at least one microphone, at least one speaker, or some combination thereof.

8. An in-vehicle monitoring system as in claim 1, wherein the at least some images are sent to the at least one interface in response to detection of a triggering event.

9. An in-vehicle monitoring system as in claim 8, wherein the triggering event comprises one or more of a verbal command, a vehicle accident, a vehicle break-in, or a police encounter.

10. An in-vehicle monitoring system as in claim 8, wherein the triggering event comprises detection of a medical emergency.

11. A method of in-vehicle monitoring, comprising:
capturing at least some images using a system including a first lens pointed in a first direction, a second lens pointed in a second direction different from the first direction, at least one camera element that receives images from at least the first lens and the second lens, at least one interface to storage for at least some images captured by the at least one camera element, and at least one in-vehicle mount for the system; and
sending the at least some images to the at least one interface in response to detection of a triggering event.

12. A method of in-vehicle monitoring as in claim 11, wherein when the first lens and the second lens point in opposite directions.

13. A method of in-vehicle monitoring as in claim 11, wherein the at least one interface comprises at least one micro SD port, SIM card port, USB port, or some combination thereof.

14. A method of in-vehicle monitoring as in claim 11, wherein the at least one interface comprises at least one wireless communication element.

15. A method of in-vehicle monitoring as in claim 11, wherein the system further comprises at least one memory; and
wherein the at least one interface comprises at least one interface to the at least one memory.

16. A method of in-vehicle monitoring as in claim 11, wherein the system further comprises a motion detection element, a location detection element, or some combination thereof.

17. A method of in-vehicle monitoring as in claim 11, wherein the system further comprises at least one microphone, at least one speaker, or some combination thereof.

18. A method of in-vehicle monitoring as in claim 11, wherein the triggering event comprises one or more of a verbal command, a vehicle accident, a vehicle break-in, or a police encounter.

19. A method of in-vehicle monitoring as in claim 11, wherein the triggering event comprises detection of a medical emergency.
